(19) United States
(12) Patent Application Publication
(10) Pub. No.: US 2025/0310130 A1
(43) Pub. Date: Oct. 2, 2025

(54) INFORMATION PROCESSING SYSTEM AND INFORMATION PROCESSING METHOD

(71) Applicant: Hitachi, Ltd., Tokyo (JP)

(72) Inventors: Takayuki NAGAI, Tokyo (JP); Tatsuya SATO, Tokyo (JP)

(21) Appl. No.: 19/058,324

(22) Filed: Feb. 20, 2025

(30) Foreign Application Priority Data
Mar. 29, 2024 (JP) 2024-056428

(51) Int. Cl. H04L 9/32

(52) U.S. Cl. CPC H04L 9/3268; H04L 9/3247

(57) ABSTRACT

An information processing system provides a certificate holder (Holder) with a verifiable credential (VC) issued by a participating organization of a distributed ledger, which is a certificate issuing organization (Issuer), for a target object and a private key corresponding to the public key of the DID of the certificate issuing organization (Issuer), and the system manages a smart contract that determines whether to allow the certificate holder (Holder) to access information about the target object in the distributed ledger based on a verifiable presentation (VP) signed by the certificate holder (Holder). The smart contract checks signatures of the verifiable credential (VC) and the verifiable presentation (VP) based on a DID document and permits the certificate holder (Holder) to access the information about the target object if the signatures are not tampered with.

### CROSS REFERENCE TO RELATED PATENTS

This application claims priority to Japanese Patent Application No. 2024-056428, filed Mar. 29, 2024, which is incorporated by reference in its entirety as if set forth in full.

### BACKGROUND

### Technical Field

The present invention relates to an information processing system and an information processing method.

### Related Art

In recent years, transactions conventionally conducted via centralized institutions and institutions such as financial governments have been recorded on a distributed ledger (blockchain) managed by a P2P (Peer-to-Peer) network system (hereinafter referred to as a “distributed ledger system”) composed of individual users' information processing apparatuses; this technology enables direct transactions between users without intermediaries such as centralized institutions (hereinafter referred to as “distributed ledger technology”), and its application is expanding into various fields.

Due to these characteristics, distributed ledger technology is being considered for application in a wide range of fields, such as finance and manufacturing, as a mechanism for managing/sharing reliable data and executing/managing transactions based on contracts. By using distributed ledger technology, information sharing and transactions can be conducted among multiple entities (such as a consortium in a specific industry or multiple companies involved in a supply chain) without management by a central authority.

Regarding systems utilizing distributed ledger technology, Japanese Patent Application Publication No. 2022-74923 (Patent Document 1), for example, describes an electronic transaction system configured to manage the confidentiality of transaction data using a distributed ledger with minimal information. In the electronic transaction system, each of the multiple nodes making up the distributed ledger that manages electronic transactions for a transaction target stores the distributed ledger; the content of the transaction target to be kept confidential is stored as actual data in nodes other than certain specified nodes; the distributed ledger is stored in and shared by all the multiple nodes; the specific nodes store the actual data of the transaction target, set access rights to the actual data stored in the specific nodes, and store the access rights in the distributed ledger.

Additionally, some platforms for implementing distributed ledger technology (hereinafter referred to as “distributed ledger platforms”) can execute smart contracts, which are logic (programs) describing transaction conditions, in addition to recording transaction data, to accommodate complex transaction conditions and diverse applications.

For example, “Hyperledger Fabric,” [online], [searched Mar. 15, 2024], Internet <URL: http://hyperledger-fabric.readthedocs.io/en/latest/> (Non-Patent Document 1) describes a distributed ledger platform having a smart contract execution function. The distributed ledger platform shares information on multiple nodes by accepting transactions while forming consensus at a predetermined consensus level among the nodes making up the distributed ledger platform, executing the transactions on each node, and holding the results.

In the distributed ledger platform technology described in Non-Patent Document 1, users participating in transactions and nodes making up the distributed ledger each hold a unique electronic certificate (digital certificate) to clarify their affiliation and authority. The electronic certificate is issued and digitally signed by the certification authority of each organization. The public key of the certification authority itself is distributed to all organizations in advance, and the validity of the electronic certificates of users and organizations participating in the distributed ledger can be confirmed by verifying the signature attached to the electronic certificate using the public key.

“Supply Chain Use Cases & Business Requirements,” [online], [searched Mar. 15, 2024], Internet <https://dlt.mobi/wp-content/uploads/2023/07/MOBI-SC0001UC2021-Version-1.1.pdf> (Non-Patent Document 2) describes the use of a distributed ledger for part recall handling and part tracing in automotive supply chains, as well as for collecting greenhouse gas emissions, reducing counterfeit parts, and so on. If customer information, including vehicle ownership, is stored in a distributed ledger as in the document, all organizations participating in the distributed ledger system can access the customer information, increasing the risk of personal information leakage. Therefore, “SSI technology” (SSI: Self-Sovereign Identity) has been attracting attention recently.

Regarding SSI technology, “Verifiable Credentials Data Model v2.0,” [online], [searched Mar. 15, 2024], Internet <https://www.w3.org/TR/vc-data-model-2.0/> (Non-Patent Document 3), for example, describes a technology for verifying certificates issued by third parties using verifiable credentials (VC) and verifiable presentations (VP) presented to a verifier.

### SUMMARY OF THE INVENTION

For example, when a consortium-type distributed ledger, in which only information processing apparatuses (hereinafter referred to as “nodes”) permitted by a specific organization can participate in transactions, is used for inter-organizational operations, a ledger containing the transaction history of all organizations participating in the distributed ledger system is shared among the organizations; this is not always desirable from the viewpoint of confidentiality for each business operator. Therefore, cases are envisioned where the ledger is shared only among organizations with a predetermined transaction relationship.

Non-Patent Document 1 describes logically dividing a distributed ledger using a concept called “Channel” to share the ledger only among organizations with a predetermined transaction relationship. The distributed ledger platform in this case is a single distributed ledger platform in which all organizations participate, but it is logically divided into multiple distributed ledger platforms internally. The set of nodes belonging to the logically divided distributed ledger platform is called a “subgroup”; the nodes belonging to the subgroup share the distributed ledger only with the nodes within the subgroup, and when executing transactions, they execute smart contracts installed for each subsystem and update the data of the distributed ledger associated with each subgroup.

However, when managing inter-organizational transactions using a distributed ledger, if “Channels” are created so that only participants in a specific transaction can refer to the detailed information (such as price) of that transaction, the number of “Channels” increases explosively according to the combination of transaction participants, resulting in difficulty in management. To address the above problem, it is conceivable to employ a mechanism that manages access rights to detailed transaction information using a dedicated smart contract, as in Patent Document 1. In Patent Document 1, when a transaction (e.g., sale of a product from company A to company B) is conducted through a smart contract, access rights to the corresponding detailed transaction information are added to the transaction participant (company B in the above example); this enables managing access rights to detailed transaction information without generating individual “Channels.”

However, Patent Document 1 does not assume that only the occurrence of a transaction of an asset, which is the substance of data, triggers a change in access rights and cannot handle, for example, expiration due to the passage of time. Furthermore, in the document, organizations without access rights to the distributed ledger cannot access the data in the distributed ledger.

In recent years, it has become common practice to ensure product traceability by extracting necessary information from the history of parts shipments and receipts and manufacturing history among businesses in a supply chain and storing it in a private distributed ledger. Currently, only organizations participating in the distributed ledger can view the business data (product data, history data, etc.) stored in the distributed ledger; however, the need may arise to disclose business data information to parties not participating in the distributed ledger, such as organizations selling the products or end-users. In such cases, it is necessary to grant access rights only to specific product or part information within the distributed ledger to those outside the participating organizations, which complicates access rights management. Currently, there is no mechanism for granting access rights only to specific product or part information to those outside participating organizations in the distributed ledger.

The present invention was made in view of such circumstances and aims to provide an information processing system and information processing method that can securely grant access to specific information to non-participants of the distributed ledger without requiring complicated access rights management.

One aspect of the present invention to achieve the above object is an information processing system that includes a plurality of nodes configured using information processing apparatuses operated by each of a plurality of organizations and coupled so as to be communicable with each other; at least some of the plurality of nodes function as nodes making up a distributed ledger system that provides a distributed ledger; the distributed ledger system can execute smart contracts in response to transactions sent from the plurality of nodes; the distributed ledger manages information about a target object and DID (Decentralized Identity) documents including the DID of each is the organization participating organization, which participating in the distributed ledger, and the public key for the DID; at least some of the plurality of nodes provide an SSI management function, which is a function for managing verifiable credentials (VCs) issued by a participating organization that is a certificate issuing organization (Issuer) using SSI technology (SSI: Self-Sovereign Identity) and verifiable presentations (VPs) issued by a participating organization that is a certificate holder (Holder) based on the verifiable credentials (VCs); the SSI management function provides the certificate holder (Holder) with the verifiable credential (VC) issued by the participating organization that is the certificate issuing organization (Issuer) for the target object and the private key corresponding to the public key for the DID of the certificate issuing organization (Issuer); the information processing system manages, as the smart contract, a program that implements the function of determining whether to allow the certificate holder (Holder) to access the information about the target object managed in the distributed ledger, based on the verifiable presentation (VP) signed by the certificate holder (Holder) using the private key.

Other problems disclosed by this application and solutions thereto will be clarified in the section of Description of Embodiments and the drawings.

According to the present invention, it is possible to securely grant access to specific information to non-participants of the distributed ledger without requiring complicated access rights management.

### BRIEF DESCRIPTION OF THE DRAWINGS

FIG. 1 is a diagram showing a schematic configuration of the information processing system;

FIG. 2 is an example of a blockchain;

FIG. 3 is an example of state information;

FIG. 4A is an example of an SC management table;

FIG. 4B is an example of a BC configuration management table;

FIG. 5 is a diagram explaining the flow from issuance of a verifiable credential (VC) to verification of a verifiable presentation (VP);

FIG. 6A is an example of a verifiable credential (VC);

FIG. 6B is an example of a verifiable presentation (VP);

FIG. 6C is an example of a schema;

FIG. 7A is a flowchart explaining the subgroup new creation process;

FIG. 7B is a flowchart explaining the SC execution process;

FIG. 7C is a flowchart explaining the business data acquisition process;

FIG. 8 is a diagram showing an application example to SCM (Supply Chain Management) in automobile manufacturing and sales; and

FIG. 9 is an example of an information processing apparatus used to implement the information processing system.

### DETAILED DESCRIPTION OF THE INVENTION

Embodiments of the present invention will be described below with reference to the drawings. The following embodiments are merely examples for explaining the present invention and are omitted and simplified as appropriate for clarity of explanation. The present invention can be implemented in other various forms. Each component may be singular or plural unless otherwise specified.

In the following description, various types of information may be described using expressions such as “information,” “data,” and “table,” but various types of information may be expressed using data structures other than these.

In the following description, when explaining identification information, expressions such as “identifier,” “ID,” and “identification information” may be used, and these can be interchanged with each other.

In the following description, the letter “S” prefixed to a symbol means a processing step.

In the following description, functions implemented by “application software” are also referred to as “apps.”

In the following, the technology that enables direct transactions between users using a blockchain (distributed ledger;

hereinafter also referred to as “BC”) is referred to as “distributed ledger technology.”

The underlying P2P (Peer-to-Peer) communication network for utilizing distributed ledger technology is hereinafter referred to as a “distributed ledger network” or “consortium.” The distributed ledger network is configured using a plurality of information processing apparatuses (hereinafter referred to as “distributed ledger nodes”) that perform two-way communication with each other via the communication network.

An organization participating in the blockchain is referred to as a “participating organization.”

A smart contract executable in a distributed ledger system is hereinafter also referred to as “SC” or “contract.”

A transaction issued to a smart contract is also referred to as “TX.” The entity of a smart contract is a program deployed on the distributed ledger system. The execution entity of the smart contract is a distributed ledger node making up the distributed ledger system.

In the following description, it is assumed that a participating organization or a member of a participating organization is identified by a combination of a private key and a public key in a public key cryptosystem (hereinafter also referred to as “identity”).

### [SSI Technology]

SSI (Self-Sovereign Identity) technology is a technology that enables selective disclosure of one's information to third parties using verifiable credentials (VCs). For example, when verifying age at a restaurant, customers are asked to present their driver's license, health insurance card, etc. In this case, although the restaurant only wants to verify whether the customer's age is legal for drinking, the customer must also present information other than age, such as name and address, to the restaurant. In such cases, by using SSI technology, it is possible to present only partial information of the verifiable credential (VC) to the verifier of the verifiable credential (VC), rather than presenting all information. Furthermore, by using zero-knowledge proof technology, the verifier can perform verification without disclosing the information in the verifiable credential (VC).

In SSI technology, a DID (Decentralized IDentifier) (also referred to as decentralized ID) is usually assigned to a person or object subject to verification. DID is a standard recommended by the W3C (World Wide Web Consortium) in 2022 and is a globally unique, persistent identifier that does not require a centralized registration authority and is often generated/registered on a distributed ledger.

To issue a verifiable credential (VC) using SSI technology, a schema and information linking a DID and a public key (hereinafter referred to as a “DID document”) must be stored in a verifiable data registry (hereinafter also referred to as “VDR”). In this embodiment, the VDR is implemented by a blockchain (BC 311 of the distributed ledger DB 310 described later).

The schema described above is information that describes what information is included in the verifiable credential (VC). For example, if the verifiable credential (VC) is a school graduation certificate, the schema describes information indicating that the verifiable credential (VC) includes name, school name, department name, graduation date, etc.

The DID document contains the DIDs and public key information of each certificate issuing organization (Issuer) and certificate holder (Holder).

The certificate issuing organization (Issuer) issues a verifiable credential (VC) to the certificate holder (Holder). The certificate issuing organization (Issuer) signs the verifiable credential (VC) using the private key corresponding to its public key included in the DID document stored in the VDR. The certificate holder (Holder) verifies the verifiable credential (VC) using the schema and DID document stored in the VDR.

The certificate holder (Holder) creates a verifiable presentation (VP) based on the verifiable credential (VC) to present to the verifier. The certificate holder (Holder) signs the verifiable presentation (VP) using the private key corresponding to its public key included in the DID document stored in the VDR.

The verifier verifies the information included in the verifiable presentation (VP) using the verifiable presentation (VP) presented by the certificate holder (Holder), the schema, and the DID document stored in the distributed ledger. The verifiable presentation (VP) includes information about the signature made by the certificate issuing organization (Issuer) on the verifiable credential (VC) that is the basis of the verifiable presentation (VP) when the verifiable credential (VC) was issued. Therefore, the verifier can verify that the verifiable presentation (VP) has not been forged (that it is based on a verifiable credential (VC) correctly issued by the certificate issuing organization (Issuer)) using the public key of the certificate issuing organization (Issuer).

Note that the verifiable credential (VC), verifiable presentation (VP), schema, and DID document are described in, for example, JSON (JavaScript Object Notation) (“Java” and “JavaScript” are both registered trademarks) format. Also, verifiable credentials (VCs) and verifiable presentations (VPs) may include unencrypted information as well as information encrypted by the certificate issuing organization (Issuer).

### [Information Processing System]

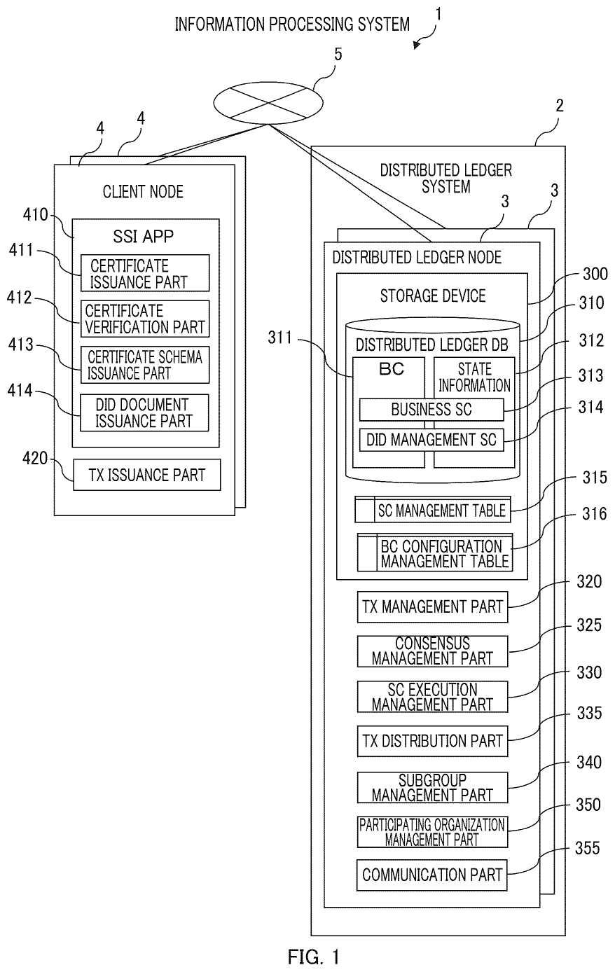

FIG. 1 shows a schematic configuration of an information processing system 1 according to an embodiment. As shown in the figure, the information processing system 1 includes a distributed ledger system 2 composed of one or more distributed ledger nodes 3 and one or more client nodes 4. The distributed ledger system 2 functions as a blockchain platform.

Each of the distributed ledger nodes 3 and client nodes 4 is configured using an information processing apparatus (computer, computing device). The distributed ledger nodes 3 and client nodes 4 are coupled via a communication network 5 so that they can communicate bidirectionally with each other. The communication network 5 is a wireless or wired communication infrastructure configured using physical communication lines, such as the Internet, a LAN (Local Area Network), a WAN (Wide Area Network), various public communication networks, or dedicated lines.

As shown in the figure, the distributed ledger node 3 has functions of a storage device 300, a TX management part (hereinafter referred to as “TX management part 320”), a consensus management part 325, a smart contract execution management part (hereinafter referred to as “SC execution management part 330”), a TX distribution part 335, a subgroup management part 340, and a communication part 355.

The distributed ledger node 3 accepts transactions via the TX management part 320 and forms consensus with other distributed ledger nodes 3 on whether to accept the transactions via the consensus management part 325. If consensus is reached, the distributed ledger node 3 deploys and executes smart contracts via the SC execution management part 330 and stores the transaction history and execution results in the distributed ledger DB 310.

In this embodiment, it is assumed that each organization making up the consortium has a distributed ledger node 3. A single organization may have multiple distributed ledger nodes 3. Multiple distributed ledger nodes 3 may share the same information to provide redundancy, thereby enhancing fault tolerance. The distributed ledger node 3 may also function as a client node 4.

Among the above functions, the storage device 300 manages (stores, records, memorizes, etc.) the distributed ledger DB 310, the SC management table 315, and the BC configuration management table 316.

The distributed ledger DB 310 includes the blockchain (hereinafter referred to as “BC 311”) and state information 312.

The BC 311 manages various types of information. For example, the BC 311 manages information related to transaction history (reception history, execution history, etc.). Smart contracts (business SC 313, DID management SC 314) are deployed in the BC 311.

The state information 312 manages information based on the transaction history and information necessary for executing smart contracts (hereinafter referred to as “state information”). The details of the state information 312 will be described later.

In this embodiment, the BC 311 is classified into multiple groups (hereinafter referred to as “subgroups”), and each BC 311 is shared among distributed ledger nodes 3 belonging to the same subgroup.

The SC management table 315 manages information related to smart contracts (business SC 313, DID management SC 314). The details of the SC management table 315 will be described later. The BC configuration management table 316 manages information about the participating organizations of BC 311. The details of the BC configuration management table 316 will be described later.

The TX management part 320 receives transactions issued by client nodes 4, distributed ledger nodes 3, etc. The TX management part 320 performs processing related to, for example, acquisition of transaction history (reception history, execution history) and execution results, presentation of transaction execution results (presentation via user interface, etc.), and addition of signatures to transactions.

The consensus management part 325 performs processing related to forming consensus with other distributed ledger nodes 3 on whether to accept received transactions. When consensus is reached, the consensus management part 325 cooperates with the SC execution management part 330 to deploy smart contracts, execute deployed smart contracts, record transaction history and transaction execution results in the distributed ledger DB 310, etc.

When consensus is reached among other distributed ledger nodes 3, the SC execution management part 330 performs processing related to deploying smart contracts, executing deployed smart contracts, etc. Consensus formation and smart contract execution do not necessarily have to be performed by all distributed ledger nodes 3 making up the distributed ledger network; consensus formation and smart contract execution may be performed among some of the distributed ledger nodes 3, and the results may be distributed to other distributed ledger nodes 3 via the communication network 5 in cooperation with the TX distribution part 335.

The TX distribution part 335 distributes the results of consensus formation and smart contract execution (transaction history, execution results, etc.) to distributed ledger nodes 3 that did not participate in the consensus formation and smart contract execution via the communication network 5. In a consortium-type distributed ledger system, each organization operates a distributed ledger node 3, and the communication part 355 performs communication between distributed ledger nodes 3, for example, when forming consensus between distributed ledger nodes 3 or distributing approved transactions.

The subgroup management part 340 provides functions related to subgroup management (new subgroup registration, update, etc.).

The communication part 355 performs processing related to communication with client nodes 4 and other distributed ledger nodes 3 via the communication network 5. For example, the communication part 355 performs communication related to consensus formation among other distributed ledger nodes 3 and distribution of approved transactions to other distributed ledger nodes 3.

The participating organization management part 350 manages information about the participating organizations and distributed ledger nodes 3 in the distributed ledger DB 310. The participating organization management part 350 performs authentication processing for the participating organizations and their members using electronic certificates and private keys corresponding to the electronic certificates. The participating organization management part 350 performs, for example, authentication of the participating organizations and their members using combinations of private keys and public keys (hereinafter referred to as “key pairs”), signing of transactions, and control of execution authority for smart contracts. Information about the private key of each distributed ledger node 3 is managed by the TX management part 320, and information about the public key is shared among all distributed ledger nodes 3. The TX management part 320 checks whether the issuer of a received transaction has appropriate authority.

The client node 4 receives various instructions and information from the user and issues transactions to the smart contract deployed on the BC 311 according to the received instructions and information. As shown in the figure, the client node 4 has functions of an SSI app 410 and a TX issuance part 420.

The SSI app 410 is used, for example, when issuing transactions to activate the business SC 313 or DID management SC performed via the TX issuance part 420 and when referring to information about the schema, public key of the certificate issuing organization, and DID used in SSI technology. The SSI app 410 also performs processing related to, for example, issuance and verification of verifiable credentials (VCs) and issuance and verification of verifiable presentations (VPs). The SSI app 410 also performs processing related to, for example, browsing information stored in the BC 311 and revoking electronic certificates (VCs and VPs).

As shown in the figure, the SSI app 410 has functions of a certificate issuance part 411, a certificate verification part 412, a certificate schema issuance part 413, and a DID document issuance part 414.

The certificate issuance part 411 performs processing related to issuing verifiable credentials (VCs) and verifiable presentations (VPs).

The certificate verification part 412 performs processing related to verifying verifiable credentials (VCs) and verifiable presentations (VPs) created by the certificate issuance part 411. The certificate verification part 412 appropriately accesses the information stored in the BC 311 for the verification.

The certificate schema issuance part 413 creates a schema for issuing a verifiable credential (VC) and stores the created schema in the BC 311.

The DID document issuance part 414 creates a DID document to be used for creating a verifiable credential (VC) and stores the created DID document in the BC 311.

The TX issuance part 420 issues transactions to the smart contract deployed on the BC 311 to the distributed ledger node 3. The transactions are accompanied by information about the issuer of the transaction (hereinafter referred to as “issuer information”). In this embodiment, the aforementioned identity is used as the issuer information. When issuing a transaction, the user signs the transaction using their private key and attaches the public key corresponding to the private key to the transaction.

### [BC (Blockchain)]

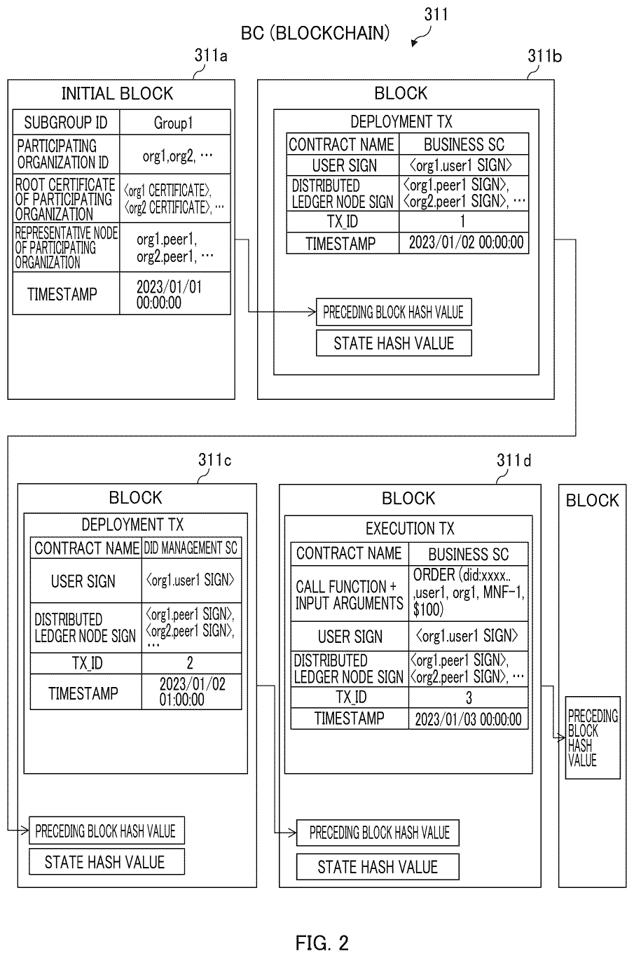

FIG. 2 is an example of the data structure of each block (a series of four blocks) of BC 311 of the distributed ledger DB 310 shown in FIG. 1. In distributed ledger technology, multiple transactions are managed as individual blocks.

BC 311 has a structure in which each block is linked to the previous block so that each block has the hash value of the previous block. This structure makes it difficult for malicious actors to tamper with the content because even a one-bit change in the value of a preceding block changes the hash values of all subsequent blocks.

Although the figure illustrates a case where one transaction corresponds to one block, multiple transactions may correspond to one block. Also, the BC 311 shown in the figure is configured such that smart contracts are linked as a single BC 311, but BC 311 may have other configurations as long as each participating organization can access it. A smart contract may be defined as multiple individual smart contracts or as a single smart contract aggregating multiple smart contracts.

Block 311a of the illustrated BC 311 contains the initial information of the subgroup. As shown in the figure, block 311a includes information such as the identifier of the subgroup corresponding to BC 311 (hereinafter referred to as “subgroup ID”), the participating organization ID, which is the identifier of the participating organization belonging to the subgroup, the root certificate of the participating organization, the name of the distributed ledger node 3 representing the participating organization, and a timestamp indicating the date and time when the block was generated.

Block 311b contains information about a transaction for deploying the business SC 313 (hereinafter referred to as a “deployment TX”). As shown in the figure, block 311b includes information such as the contract name uniquely identifying the contract, the signature of the user who issued the deployment TX, the signature of the distributed ledger node 3 that received the transaction, the TX ID, which is the identifier of the deployment TX, and a timestamp indicating the date and time when the deployment TX was issued.

Block 311c contains information about the deployment TX of the DID management SC 314. As shown in the figure, block 311c includes information as such the contract name uniquely identifying the contract, the signature of the user who issued the deployment TX, the signature of the distributed ledger node 3 that received the deployment TX, the TX ID, which is the identifier of the deployment TX, and a timestamp indicating the date and time when the deployment TX was issued.

Block 311d contains information about a transaction for executing the deployed business SC 313 (hereinafter referred to as an “execution TX”). As shown in the figure, block 311d includes information such as the contract name, the function name of the contract and its input arguments (in this example, “did:xxxx.., user1, org1, MNF-1, $100”), the signature of the user who issued the execution TX, the signature of the distributed ledger node 3 that received the execution TX, the TX ID, which is the identifier of the execution TX, and a timestamp indicating the date and time when the execution TX was issued.

### [State Information]

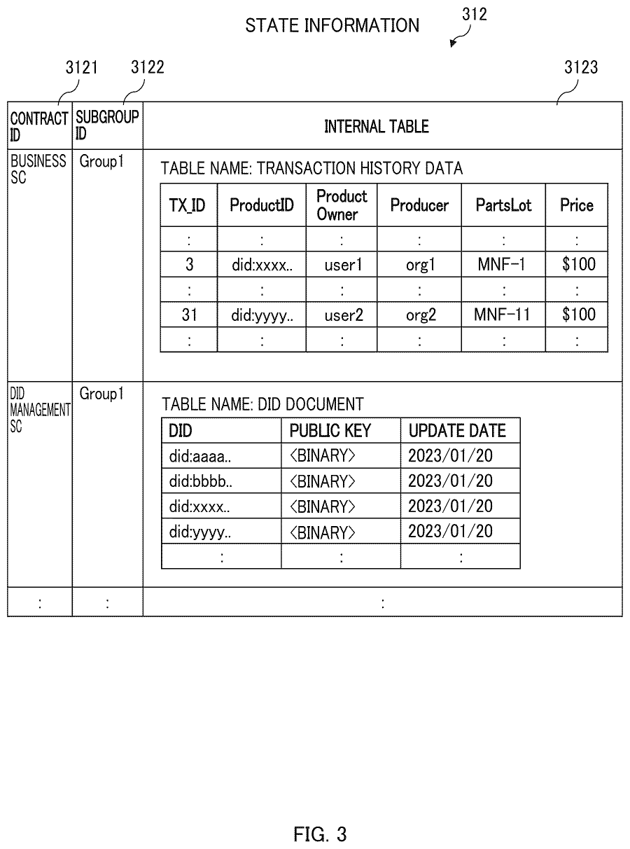

FIG. 3 shows an example of state information 312 managed in the distributed ledger DB 310 shown in FIG. 1. In an information management mechanism using a blockchain, it is inefficient to sequentially trace the blockchain to acquire the latest state of information managed (stored) in the blockchain (e.g., the latest balance of virtual currency when the blockchain manages virtual currency).

Therefore, in this embodiment, a mechanism is employed for managing the latest state of the information managed in the blockchain as state information 312. A mechanism similar to the above mechanism is disclosed in, for example, Non-Patent Document 1 (“Hyperledger Fabric,” [online], [searched Mar. 15, 2024], Internet <URL: http://hyperledger-fabric.readthedocs.io/en/latest/>). In this embodiment, it is assumed that a data area of state information 312 is prepared for each function of a contract.

The state information 312 is managed, for example, in a table of a database managed by BC 311 or a DBMS (Database Management System) such as NoSQL. The state information 312 includes, for example, information based on the results of transaction execution managed in a key-value format.

The illustrated state information 312 is composed of one or more records having items such as a contract ID 3121, a subgroup ID 3122, and an internal table 3123. One record of the state information 312 corresponds to one smart contract.

Among the above items, the contract ID 3121 stores the identifier of the smart contract (hereinafter referred to as “contract ID”).

The subgroup ID 3122 stores the subgroup ID, which is the identifier of the subgroup to which the contract is associated.

The internal table 3123 stores information (data) managed as state information 312. The content of the internal table 3123 is updated as needed by issuing an execution TX and executing the corresponding smart contract.

In this example, the internal table 3123 stores “Transaction History Data,” which is information (table) updated by the business SC 313, a smart contract that performs processing for accessing the BC 311 regarding business related to product and goods transactions, and “DID Document,” which is information (table) updated by the DID management SC 314, a smart contract that performs processing for accessing the BC 311 regarding management of DID-related information.

In the illustrated internal table 3123, the “transaction history data” is composed of one or more records having items such as “TX ID,” “ProductID,” “ProductOwner,” “Producer,” “PartsLot,” and “Price.” “TX ID” stores the transaction identifier. “ProductID” stores the product identifier. “ProductOwner” stores the identifier of the product owner. In this example, the product's DID is stored in “ProductID.” “Producer” stores the identifier of product the manufacturer (manufacturing organization). “PartsLot” stores information indicating the lot of the product. “Price” stores the sales price of the product.

In the illustrated internal table 3123, the “DID Document” is composed of one or more records having items such as “DID,” “Public Key,” and “Update Date.” Among them, “DID” stores the DID. “Public Key” stores the entity of the public key associated with the DID. “Update Date” stores the most recent update date of the record.

### [SC Management Table]

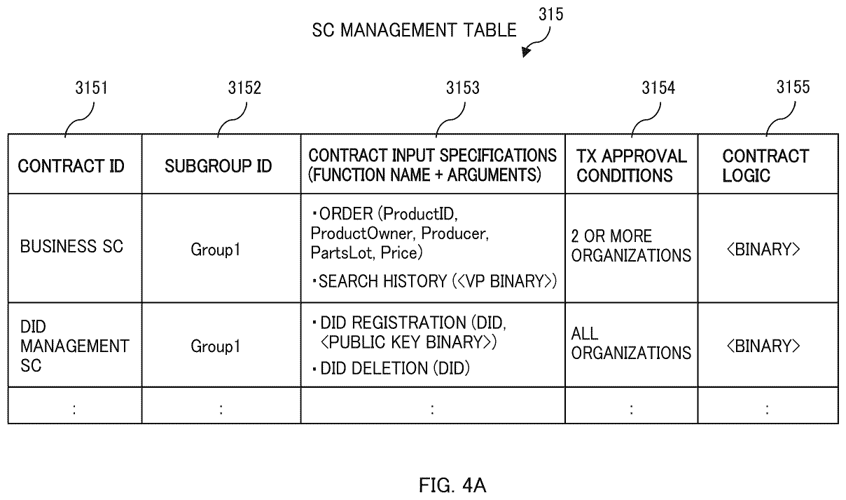

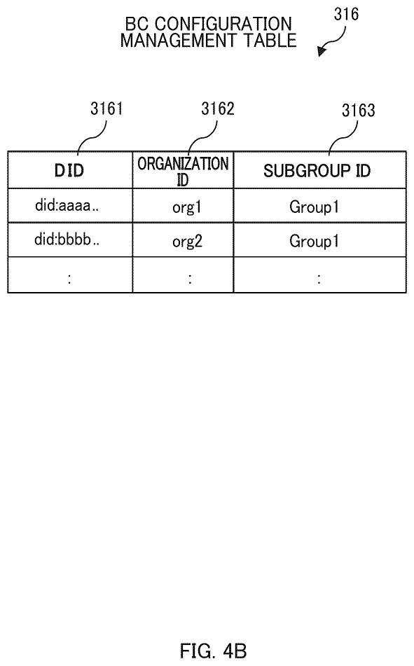

FIG. 4A shows an example of the SC management table 315 managed by the storage device 300 shown in FIG. 1. As shown in the figure, the illustrated SC management table 315 is composed of one or more records having items such as a contract ID 3151, a subgroup ID 3152, contract input specifications 3153, TX approval conditions 3154, and contract logic 3155. One record of the SC management table 315 corresponds to one smart contract.

Among the above items, contract ID 3151 stores the contract ID of the contract. Subgroup ID 3152 stores the subgroup ID of the subgroup to which the contract is associated. Contract input specifications 3153 store the function names and arguments of the contract. TX approval conditions 3154 store the conditions required to approval obtain the transaction among for participating organizations. Contract logic 3155 stores the entity of the contract (for example, executable binary data (execution code), etc.).

FIG. 4B shows an example of the BC configuration management table 316 managed by the storage device 300 shown in FIG. 1. As shown in the figure, the illustrated BC configuration management table 316 is composed of one or more records having items such as a DID 3161, an organization ID 3162, and a subgroup ID 3163. One record of the BC configuration management table 316 corresponds to one DID.

Among the above items, DID 3161 stores the DID of the participating organization. Organization ID 3162 stores the identifier of the participating organization having the DID (hereinafter referred to as “organization ID”). Subgroup ID 3163 stores the subgroup ID of the subgroup to which the participating organization belongs.

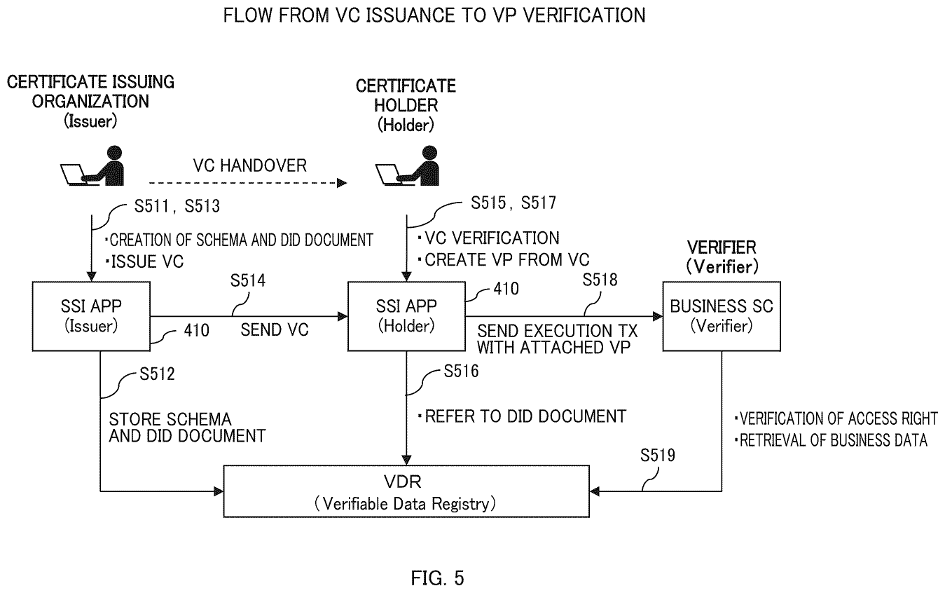

FIG. 5 is a diagram explaining the flow from issuance of a verifiable credential (VC) to verification of a verifiable presentation (VP) performed using the SSI app 410 and business SC 313.

In the following description, the certificate issuing organization (Issuer) is, for example, a manufacturer (such as an automobile manufacturer) or provider of a product such as an automobile. The certificate holder (Holder) is, for example, a delivery destination of a product manufactured by the certificate issuing organization (Issuer) (a purchaser of a product sold by the certificate issuing organization (Issuer), etc.). The verifier is, for example, a smart contract used by the certificate holder (Holder) (for example, the business SC 313 shown in FIG. 1).

First, to issue a verifiable credential (VC) (e.g., a delivery note or certificate of ownership) to be given to the certificate holder (Holder), the certificate issuing organization (Issuer) uses the SSI app 410 to create a schema and a DID document and stores the created schema and DID document in the VDR. Specifically, the certificate issuance part 411 of the SSI app 410 creates the schema and stores it in the VDR. The certificate schema issuance part 413 of the SSI app 410 creates a pair of public and private keys (key pair) associated with the certificate issuing organization (Issuer) (S511) and stores the DID document containing the public key of the key pair and the DID in the VDR (S512).

Next, the certificate issuing organization (Issuer) creates the verifiable credential (VC) to be issued to the certificate holder (Holder) using the previously created private key (S513) and sends the created verifiable credential (VC) to the certificate holder (Holder) (S514).

The certificate holder (Holder) verifies whether the information contained in the received verifiable credential (VC) is correct using the SSI app 410 (S515). Specifically, the TX issuance part 420 of the certificate verification part 412 of the SSI app 410 sends a request to the VDR, obtains the DID document stored in the VDR (S516), and the certificate holder (Holder) verifies whether the information contained in the received verifiable credential (VC) is correct based on the obtained DID document. If the content of the verifiable credential (VC) is correct, the certificate holder (Holder) saves it; if it is incorrect, the certificate holder (Holder) requests the certificate issuing organization (Issuer) to create or recreate the verifiable credential (VC).

Next, the certificate holder (Holder) uses the SSI app 410 to create a verifiable presentation (VP) to be given to the verifier, which is the business SC 313 (S517). The verifiable presentation (VP) contains some or all of the information in the verifiable credential (VC), and the verifier can verify the verifiable credential (VC) received from the certificate issuing organization (Issuer) by checking the verifiable presentation (VP).

Next, to access the business data in the BC 311 (e.g., the product manufacturing history used as product trace information in SCM (Supply Chain Management)), the certificate holder (Holder) issues an execution TX for the business SC 313 with the created verifiable presentation (VP) attached (S518).

The business SC 313 obtains the DID document stored in the VDR and uses the obtained DID document to verify that the verifiable presentation (VP) attached to the execution TX was correctly created from the verifiable credential (VC) issued by the certificate issuing organization (Issuer) and that the signature of the certificate holder (Holder) is correct.

If the verification is successful, the business SC 313 refers to the BC configuration management table 316 and checks whether the DID described in the verifiable presentation (VP) is the DID of a participating organization. If the DID described in the verifiable presentation (VP) is the DID of a participating organization, the business SC 313 determines that the certificate holder (Holder) can access the business data in the BC 311. If it is determined that the business data in the BC 311 is accessible, the business SC 313 accesses the business data in the BC 311, obtains the information indicated in the disclosure scope of the verifiable presentation (VP), and returns the obtained information to the SSI app 410 of the certificate holder (Holder).

On the other hand, if the DID described in the verifiable presentation (VP) is not the DID of a participating organization, the business SC 313 returns “access denied” to the SSI app 410 of the certificate holder (Holder) (S519).

### [Verifiable Credential (VC)]

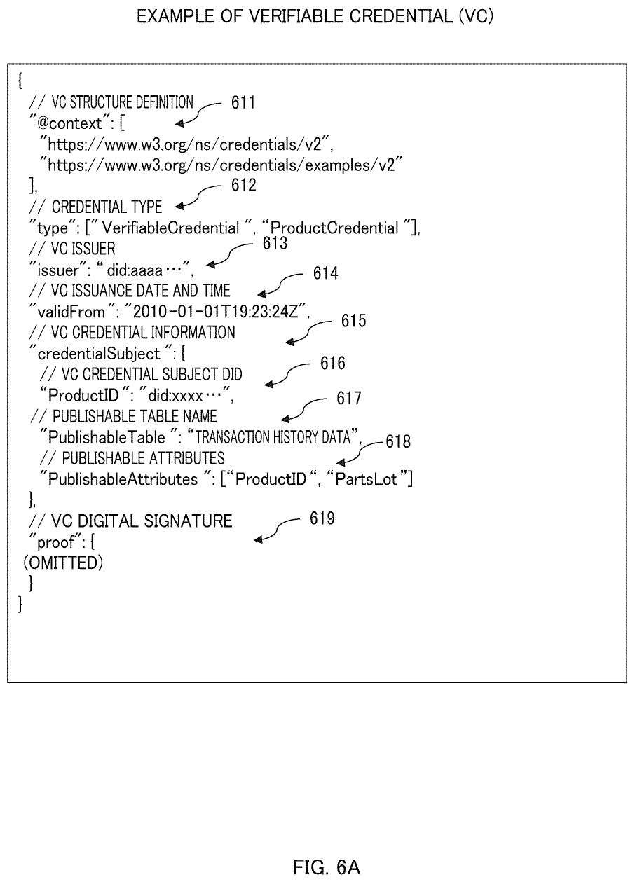

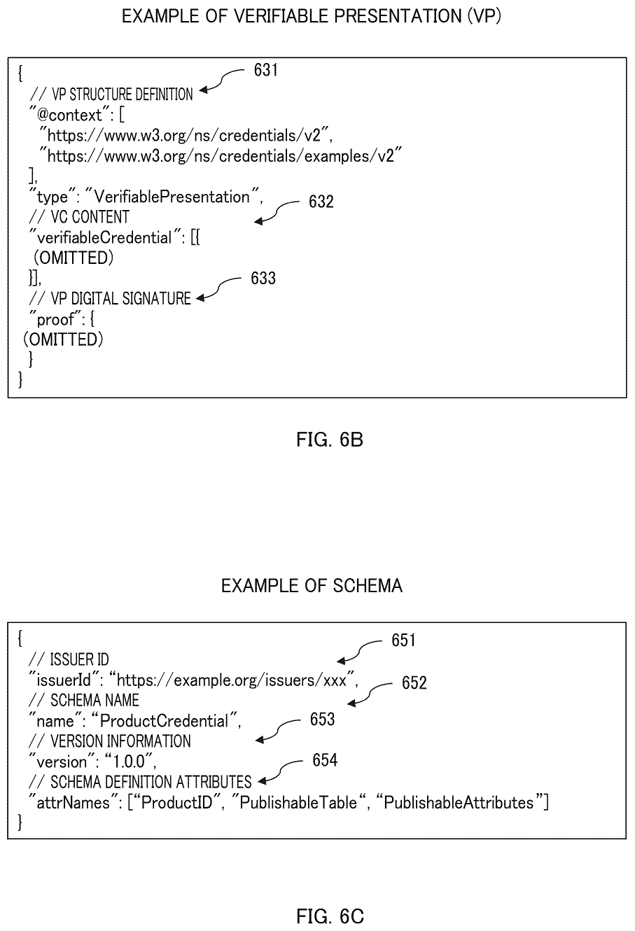

FIG. 6A shows an example of a verifiable credential (VC). The illustrated verifiable credential (VC) includes information such as VC structure definition 611, credential type 612, VC issuer 613, VC issuance date and time 614, VC credential information 615, VC credential subject DID 616, publishable table name 617, publishable attributes 618, and VC digital signature 619.

VC structure definition 611 describes information about the structure definition of the verifiable credential (VC).

Credential type 612 describes information indicating the type of credential (“VerifiableCredential,” “ProductCredential,” etc.). The information includes the name of the schema.

VC issuer 613 describes information indicating the issuer of the verifiable credential (VC) (including the issuer's DID).

VC issuance date and time 614 describes information indicating the date and time when the verifiable credential (VC) was issued.

VC credential information 615 describes information that specifies the object certified by the verifiable credential (VC) (e.g., a product or item; hereinafter also referred to as “credential subject”).

VC credential subject DID 616 describes the DID of the credential subject of the verifiable credential (VC).

Publishable table name 617 and publishable attributes 618 describe information indicating the information that can be disclosed to the certificate holder (Holder) among the information described in the verifiable credential (VC).

VC digital signature 619 describes the digital signature information (digital signature entity) attached to the verifiable credential (VC).

[Verifiable Presentation (VP)]

FIG. 6B shows an example of a verifiable presentation (VP). The illustrated verifiable presentation (VP) includes information such as VP structure definition 631, VC content 632, and VP digital signature 633.

VP structure definition 631 describes information about the structure definition of the verifiable presentation (VP).

VC content 632 describes the information of the verifiable credential (VC) that is the source of the verifiable presentation (VP).

VP digital signature 633 describes the digital signature information (digital signature entity) attached to the verifiable presentation (VP).

### [Schema]

FIG. 6C shows an example of a schema. The illustrated schema includes information such as issuer ID 651, schema name 652, version information 653, and schema definition attributes 654.

Issuer ID 651 describes information indicating the issuer of the schema.

Schema name 652 describes the name of the schema.

Version information 653 describes information indicating the version of the schema.

Schema definition attributes 654 describe information defined in the schema (information indicating information (attributes) included in the verifiable credential (VC)).

Next, the main processes performed in the information processing system 1 will be described with flowcharts.

### [Subgroup New Creation Process]

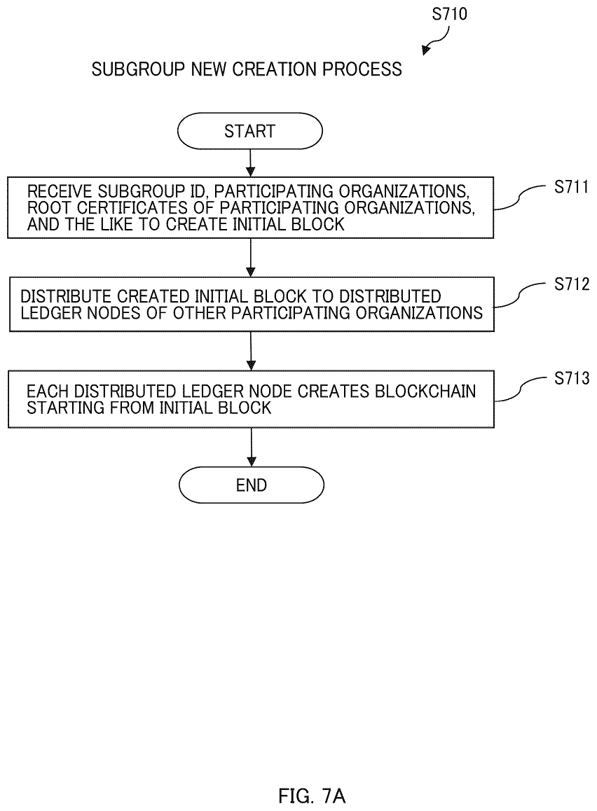

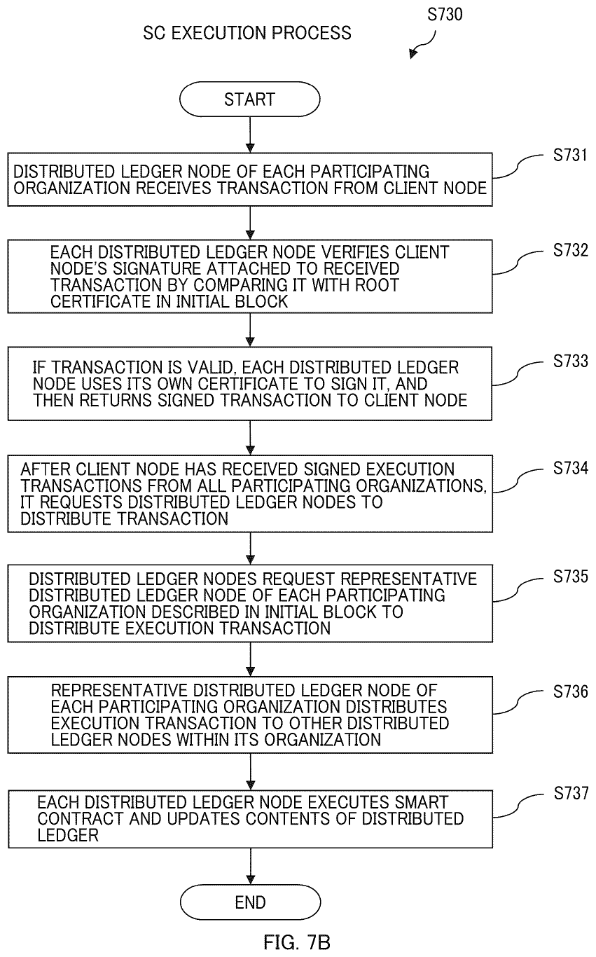

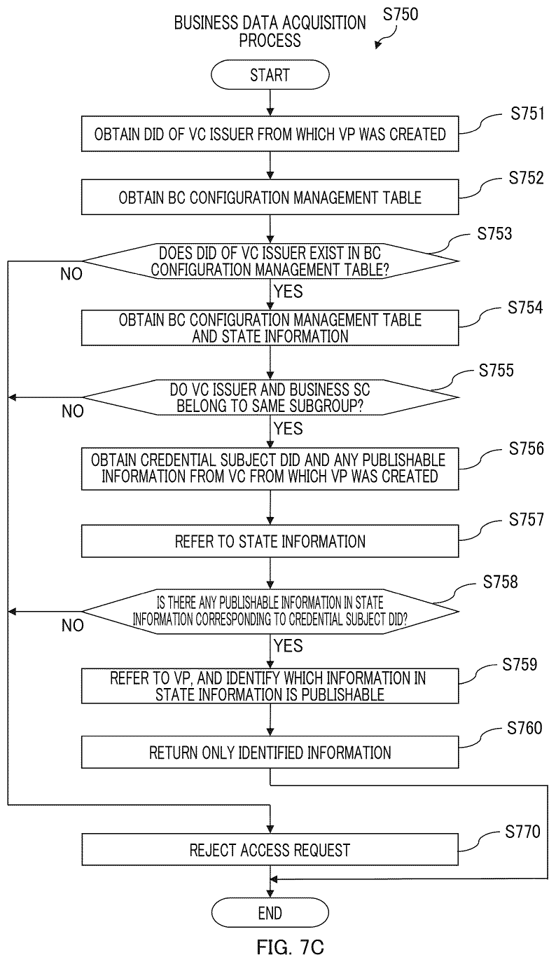

FIG. 7A is a flowchart explaining a process performed by the subgroup management part 340 of the distributed ledger node 3 when creating a new subgroup for a participating organization (hereinafter referred to as “subgroup new creation process S710”). The subgroup new creation process S710 will be described below with reference to the figure.

First, the subgroup management part 340 receives information necessary for subgroup creation, such as the subgroup ID, participating organization ID, root certificate of the participating organization, name of the representative node of the participating organization, and restriction condition TX formulation logic, from the administrator of BC 311, etc., and creates an initial block of BC 311 (e.g., block 311a shown in FIG. 2) based on the received information (S711). The administrator is assumed to have consulted with the participating organizations in advance and obtained agreement on the above information. The subgroup management part 340 performs the above reception via, for example, a user interface provided by the distributed ledger node 3 or client node 4.

Next, the subgroup management part 340 sends the created initial block to the subgroup management part 340 of the distributed ledger nodes 3 of other participating organizations (S712). This allows each participating organization's distributed ledger node 3 to share the initial block.

Next, the subgroup management part 340 of each participating organization's distributed ledger node 3 creates BC 311 starting from the initial block in the distributed ledger DB 310 (S713).

### [TX Execution Process]

FIG. 7B is a flowchart explaining a process performed by the SC execution management part 330 of the distributed ledger node 3 when receiving a transaction from the client node 4 (hereinafter referred to as “SC execution process S730”). The SC execution process S730 will be described below with reference to the figure.

First, the SC execution management part 330 of each distributed ledger node 3 receives the transaction issued by the TX issuance part 420 of the client node 4 (S731). The transaction is accompanied by information such as the name or identifier (contract ID) of the smart contract to be executed, the function name, and arguments. The client node 4 signs the transaction using its private key and attaches the electronic certificate of the signature (the public key of the private key) to the transaction.

Next, each distributed ledger node 3 verifies whether the client node 4's signature attached to the received transaction is valid by comparing it with the root certificate in the initial block (S732).

If the signature is valid, each distributed ledger node 3 signs the transaction using its private key and sends the signed transaction to the client node 4 (S733).

When the client node 4 receives signed transactions from all participating organizations' distributed ledger nodes 3 (consensus reached), it requests the TX management part 320 of an arbitrary distributed ledger node 3 to distribute the transaction (S734).

Upon receiving the request, the TX management part 320 of the distributed ledger node 3 sends the transaction to the TX distribution part 335. Upon receiving the transaction, the TX distribution part 335 assigns an identifier to the transaction and requests the representative distributed ledger nodes 3 of the other participating organizations described in the initial block to distribute the transaction (S735).

Upon receiving the request, the representative distributed ledger node 3 of each participating organization identifies other distributed ledger nodes 3 of its organization from the participating organization management part 350 and sends the transaction to the identified distributed ledger nodes 3 (S736). The SC execution management part 330 of each distributed ledger node 3 executes the smart contract specified in the transaction (S737).

If the transaction is a deployment TX, the contract ID and contract entity are registered as state information 312 on the distributed ledger, and the block of the deployment TX is added to the end of the BC 311.

If the transaction is an execution TX, the smart contract having the contract ID specified in the transaction is executed by giving the call function and input arguments attached to the transaction. When the smart contract is executed, the content of the distributed ledger DB 310 is updated according to the execution result. Specifically, the content of the state information 312 regarding the contract is updated, and the block of the transaction is added to the end of the BC 311 (S738).

In the above process, the transaction is broadcast to other distributed ledger nodes 3 via the TX distribution part 335 of the distributed ledger node 3, but the method of distributing the transaction is not limited thereto. For example, a dedicated node for distributing transactions to each distributed ledger node 3 may be provided, and the node may distribute the transactions to each distributed ledger node 3 via the communication network 5.

### [Business Data Acquisition Process]

FIG. 7C is a flowchart explaining the process performed by the business SC 313 of the distributed ledger node 3, which functions as a verifier in FIG. 5, when it receives an execution TX with a verifiable presentation (VP) attached from the SSI app 410 operated by the certificate holder (Holder) (hereinafter referred to as “business data acquisition process S750”). The business data acquisition process S750 will be described below along with the figure. It is assumed that the execution TX is an execution TX that instructs the acquisition of predetermined business data stored in BC 311.

First, the business SC 313 refers to the verifiable presentation (VP) received from the certificate holder (Holder) and obtains the DID of the issuer of the verifiable credential (VC) from which the verifiable presentation (VP) was created (S751).

Next, the business SC 313 obtains the BC configuration management table 316 (S752) and checks whether the DID of the issuer of the verifiable credential (VC) exists in the BC configuration management table 316 (whether the issuer of the verifiable credential (VC) is a participating organization) (S753). If the DID of the issuer of the verifiable credential (VC) exists in the BC configuration management table 316 (S753: Yes), the process proceeds to S754. On the other hand, if the DID of the issuer of the verifiable credential (VC) does not exist in the BC configuration management table 316 (S753: No), the business SC 313 returns “access denied” to the SSI app 410 operated by the certificate holder (Holder) (S770), and the business data acquisition process S750 ends.

In S754, the business SC 313 acquires the BC configuration management table 316 and state information 312. The business SC 313 then checks whether the subgroup to which the organization corresponding to the DID of the issuer of the verifiable credential (VC) belongs is the same as the subgroup (subgroup ID 3122) of the business SC 313 in the state information 312 (S755). If both subgroups are the same (S755: Yes), the process proceeds to S756. On the other hand, if both subgroups are not the same (S755: No), the business SC 313 returns “access denied” to the SSI app 410 operated by the certificate holder (Holder) (S770), and the business data acquisition process S750 ends.

In S756, the business SC 313 obtains the credential subject DID and the publishable information of the verifiable credential (VC) from which the verifiable presentation (VP) was created.

Next, the business SC 313 refers to the internal table 3123 of the state information 312 that matches the acquired publishable table name (S757). Then, the business SC 313 checks whether the publishable information corresponding to the acquired credential subject DID exists in the internal table 3123 of the state information 312 (S758). If it exists (S758: Yes), the process proceeds to S759. If it does not exist (S758: No), the business SC 313 returns “access denied” to the SSI app 410 operated by the certificate holder (Holder) (S770), and the business data acquisition process S750 ends.

For example, in the verifiable credential (VC) of FIG. 6A, “‘ProductID’: ‘did: xxxx . . . ’” is set in VC credential subject DID 616, and “‘PublishableTable’: ‘Transaction History Data’” is set in publishable table name 617, and the internal table 3123 of state information 312 includes the table “Transaction History Data” corresponding to them. Therefore, in this case, the business SC 313 determines that the publishable information corresponding to the acquired credential subject DID exists in the internal table 3123 of state information 312.

In S759, the business SC 313 identifies the information that is publishable in the verifiable presentation (VP) among the information stored in the state information 312.

Next, the business SC 313 acquires the identified information from the publishable information whose existence was confirmed in S758 and returns the acquired information to the SSI app 410 operated by the certificate holder (Holder) (S760). This completes the business data acquisition process S750.

### APPLICATION EXAMPLE

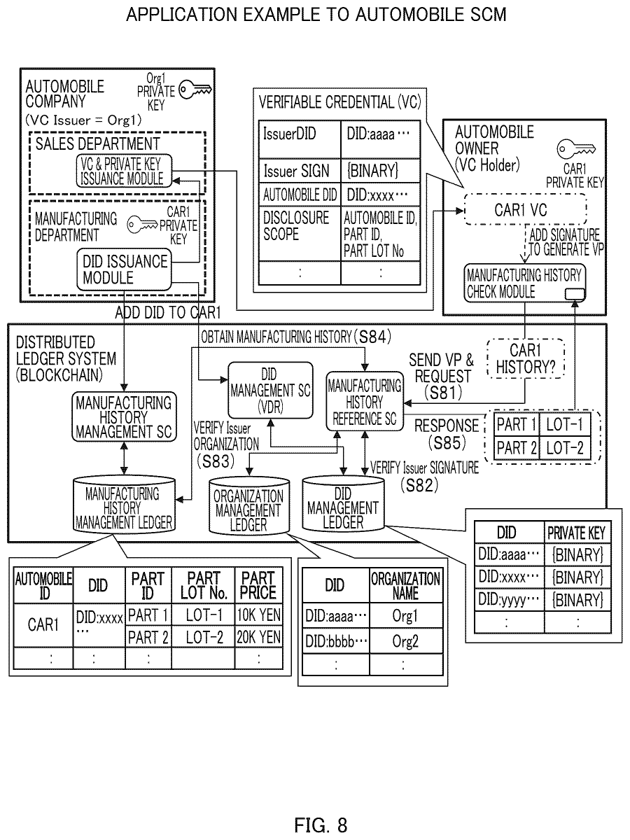

FIG. 8 shows an application example of the information processing system 1 described above to SCM in product manufacturing and sales.

In the figure, the “Automobile Company,” which is the manufacturer of the product (automobile) that is the subject of the transaction, corresponds to the certificate issuing organization (Issuer), and the “Car Owner,” who is the owner of the automobile, corresponds to the certificate holder (Holder).

The sales department of the “Automobile Company,” which is the certificate issuing organization (Issuer), issues a verifiable credential (VC) and a private key for the automobile “CAR1” to the certificate holder (Holder), who is the purchaser of the automobile “CAR1,” at the time of sale. This verifiable credential (VC) functions, for example, as a certificate indicating that the certificate holder (Holder) is the legitimate owner.

The manufacturing department of the “Automobile Company,” which is the certificate issuing organization (Issuer), manages information about the manufacturing history of automobiles (business data, transaction history data) in the state information (corresponding to state information 312) of the distributed ledger system as a “Manufacturing History Management Ledger.”

The “VC & Private Key Issuance Module” used by the sales department of the “Automobile Company” shown in the figure and the “DID Issuance Module” used by the manufacturing department of the “Automobile Company” correspond to the functions of the SSI app 410 used by the certificate issuing organization (Issuer) shown in FIG. 5.

The “Manufacturing History Check Module” used by the car purchaser shown in the figure corresponds to the functions of the SSI app 410 used by the certificate holder (Holder).

The “Manufacturing History Management SC” and “Manufacturing History Reference SC” in the distributed ledger system shown in the figure correspond to the business SC 313 described above. The “DID Management SC (VDR)” shown in the figure corresponds to the DID management SC 314 described above.

The “Organization Management Ledger” shown in the figure corresponds to the BC configuration management table 316 described above. The “DID Management Ledger” shown in the figure corresponds to the table “DID Document” managed in the state information 312 described above.

The manufacturing department of the automobile company issues the DID of the automobile “CAR1” using the “DID Issuance Module” at the time of sale and sets the issued DID in the history data of the automobile “CAR1” in the “Manufacturing History Management Ledger.”

Here, assume that the “Car Owner,” who is the certificate holder (Holder), accesses the information stored in the “Manufacturing History Management Ledger” of the automobile “CAR1.”

In this case, first, the “Car Owner” generates a verifiable presentation (VP) by adding their signature to the verifiable credential (VC) received from the “Automobile Company,” which is the certificate issuing organization (Issuer).

Next, the “Car Owner” operates the “Manufacturing History Check Module” and issues (sends) a request (transaction) to the “Manufacturing History Reference SC” with the verifiable presentation (VP) attached to inquire about the manufacturing history of the automobile “CAR1” (S81).

Upon receiving the request, the “Manufacturing History Reference SC” refers to the “DID Management Ledger” and verifies the DID and signature of the certificate issuing organization (Issuer) (S82).

Next, the “Manufacturing History Reference SC” refers to the “Organization Management Ledger” and checks whether the DID of the certificate issuing organization (Issuer) attached to the verifiable presentation (VP) belongs to a participating organization (S83); if it belongs to a participating organization, it permits reference to the Manufacturing History Management Ledger (history data of state information 312) (S84). At this time, the “Manufacturing History Reference SC” identifies the DID of the automobile “CAR1” from the verifiable presentation (VP) and determines that the “Car Owner” has access rights to the “Manufacturing History Management Ledger” for the information described in the “Disclosure Scope” of the verifiable credential (VC) among the history data related to the automobile “CAR1.”

Next, the Manufacturing History Reference SC obtains the information determined to have access rights (information permitted to be referenced) from the “Manufacturing History Management Ledger” and returns the obtained information to the “Manufacturing History Check Module” operated by the “Car Owner” (S85).

According to the above mechanism, it is possible to grant access to the “Manufacturing History Management Ledger” stored in the blockchain of the distributed ledger system to the “Car Owner,” who is not a participating organization of the blockchain, and to provide the content of the “Manufacturing History Management Ledger” to the “Car Owner.” It is also possible to provide the “Car Owner” with only the information related to the automobile “CAR1” owned by the “Car Owner,” not the entire “Manufacturing History Management Ledger.”

### =Example of Information Processing Apparatus=

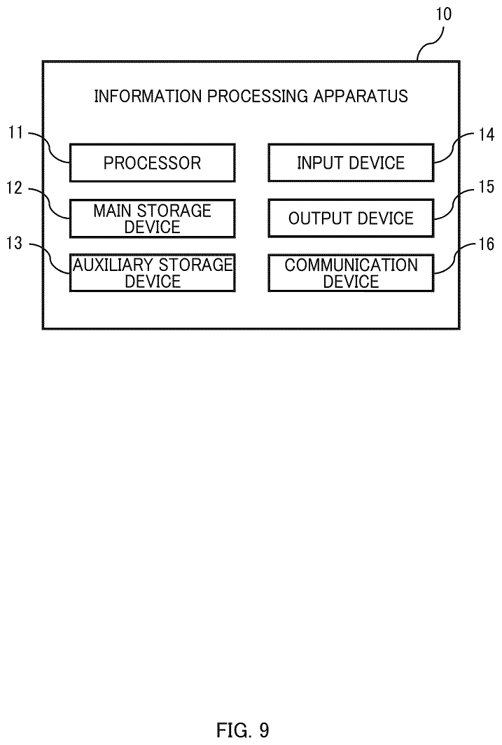

FIG. 9 is an example of an information processing apparatus (computer) used to implement the information processing system 1 described in the above embodiments. The client node 4 and distributed ledger node 3 are configured using, for example, the illustrated information processing apparatus 10.

The information processing apparatus 10 includes a processor 11, a main storage device 12 (memory), an auxiliary storage device 13 (external storage device), an input device 14, an output device 15, and a communication device 16. These are communicably coupled via a bus, communication cable, etc. Examples of the information processing apparatus 10 include personal computers, various server devices, office computers, mainframes, smartphones, and tablets.

All or part of the information processing apparatus 10 may be implemented using virtual information processing resources provided using virtualization technology, process space separation technology, etc., such as a virtual server provided by a cloud system. All or part of the functions provided by the information processing apparatus 10 may also be implemented by services provided by a cloud system via an API (Application Programming Interface), etc. All or part of the functions provided by the information processing apparatus 10 may also be implemented using Saas (Software as a Service), Paas (Platform as a Service), IaaS (Infrastructure as a Service), etc.

The processor 11 is configured using, for example, a CPU (Central Processing Unit), an MPU (Micro Processing Unit), a GPU (Graphics Processing Unit), an FPGA (Field Programmable Gate Array), an ASIC (Application Specific Integrated Circuit), or an AI (Artificial Intelligence) chip.

The main storage device 12 is a device used when the processor 11 executes programs, such as a ROM (Read Only Memory), a RAM (Random Access Memory), or a non-volatile memory (NVRAM (Non-Volatile RAM)). Various functions implemented in each component of the information processing system 1 are realized by each processor 11 reading out and executing programs and data stored (memorized) in the auxiliary storage device 13 to the main storage device 12.

The auxiliary storage device 13 is a device that stores programs and data, such as an SSD (Solid State Drive), a hard disk drive, an optical storage device (CD (Compact Disc), DVD (Digital Versatile Disc), etc.), various storage systems such as NAS (Network Attached Storage), an IC card, a reading/writing device for non-transitory recording media such as SD cards and optical recording media, a non-transitory storage area of a cloud server, etc. The auxiliary storage device 13 can read programs and data from non-transitory recording media and other information processing apparatuses having non-transitory storage devices via a recording medium reading device or the communication device 16. Programs and data stored (memorized) in the auxiliary storage device 13 are read into the main storage device 12 as needed.

The input device 14 is an interface that receives information input from the outside, such as a keyboard, mouse, touch panel, card reader, pen-input tablet, or voice input device.

The output device 15 is an interface that outputs various information such as processing progress and processing results to the outside. The output device 15 is, for example, a display device that visualizes the various information (liquid crystal monitor, LCD (Liquid Crystal Display), graphics card, etc.), a device that converts the various information into audio (audio output device (speaker, etc.)), or a device that converts the various information into characters (printing device, etc.). The information processing apparatus 10 may input and output information to and from other devices via the communication device 16.

The input device 14 and the output device 15 makes up a user interface that realizes interactive processing (information reception, information provision, etc.) with the user.

The communication device 16 is a device that enables communication with other devices. The communication device 16 is a wired or wireless communication interface that enables e communication with other devices via the communication network 5, such as a NIC (Network Interface Card), a wireless communication module, or a USB module.

The information processing apparatus 10 may have, for example, an operating system, a file system, a DBMS (Database Management System) (relational database, NoSQL, etc.), or a KVS (Key-Value Store) installed.

[Technical Effects, etc.]

As described above, according to the information processing system 1 of this embodiment, it is possible to grant access to the information stored in the BC 311 to persons other than participating organizations who have a verifiable presentation (VP) including the signature of a participating organization. Therefore, it is unnecessary to manage the troublesome tasks of issuing and revoking user accounts (execution due to change of ownership, etc.) for persons other than participating organizations to refer to the information stored in BC 311, and a mechanism for allowing persons other than participating organizations to access the information in BC 311 can be implemented efficiently and securely.

It is also possible to grant access rights to information related to a specific target object, not all information stored in the BC 311, to non-participating organizations.

It is also possible to grant access rights only to the disclosable information specified in the verifiable credential (VC) among the information stored in the BC 311 to non-participating organizations.

For example, service vendors that use distributed ledger technology to provide information about the traceability of target objects (products, etc.) in SCM such as automobile manufacturing and sales can improve the value of their services.

As described above, according to the information processing system 1 of this embodiment, it is possible to securely permit access to specific information to non-participants of the distributed ledger without requiring complicated access rights management.

Although embodiments have been described above, the present invention is not limited to the above embodiments but includes various modifications and is not necessarily limited to those having all the configurations described. It is also possible to replace a part of the configuration of one embodiment with the configuration of another embodiment, and to add the configuration of another embodiment to the configuration of one embodiment. It is also possible to add, delete, or replace a part of the configuration of each embodiment with another configuration.

What is claimed is:

1. An information processing system comprising:
a plurality of nodes configured using information processing apparatuses operated by each of a plurality of organizations and coupled so as to be communicable with each other, wherein
at least some of the plurality of nodes function as nodes making up a distributed ledger system that provides a distributed ledger,
the distributed ledger system is capable of executing a smart contract in response to a transaction sent from the plurality of nodes,
the distributed ledger system manages, in the distributed ledger, information about a target object and DID (Decentralized Identity) documents including a DID of each participating organization, which is an organization participating in the distributed ledger, and a public key for the DID,
at least some of the plurality of nodes provide an SSI management function, which is a function for managing a verifiable credential (VC) issued by a participating organization that is a certificate issuing organization (Issuer) using SSI technology (SSI: Self-Sovereign Identity) and a verifiable presentation (VP) issued by a participating organization that is a certificate holder (Holder) based on the verifiable credential (VC),
the SSI management function provides the certificate holder (Holder) with the verifiable credential (VC) issued by the participating organization that is the certificate issuing organization (Issuer) for the target object and a private key corresponding to the public key for the DID of the certificate issuing organization (Issuer), and
the SSI management function manages, as the smart contract, a program that implements a function of determining whether to allow the certificate holder (Holder) to access the information about the target object managed in the distributed ledger, based on the verifiable presentation (VP) signed by the certificate holder (Holder) using the private key.

2. The information processing system according to claim 1, wherein the smart contract implements function of, when determining whether to allow the certificate holder (Holder) to access the information about target the object, checking signatures attached to the verifiable credential (VC) and the verifiable presentation (VP) based on the DID document and, if the signatures attached to the verifiable credential (VC) and the verifiable presentation (VP) have not been tampered with, allowing the certificate holder (Holder) to access the information about the target object.

3. The information processing system according to claim 2, wherein the distributed ledger system stores an organization management ledger including information indicating the participating organizations, and the smart contract implements a function of, when determining whether to allow the certificate holder (Holder) to access the information about the target object, checking whether the organization that issued the verifiable credential (VC) is included in the organization management ledger and, if the organization that issued the verifiable credential (VC) is included in the organization management ledger, allowing the certificate holder (Holder) to access the information about the target object.

4. The information processing system according to claim 3, wherein the verifiable credential (VC) includes an identifier of the target object, the information about the target object managed in the distributed ledger includes the identifier, and the smart contract implements a function of, when determining whether to allow the certificate holder (Holder) to access the information about the target object, checking whether the identifier of the target object included in the verifiable credential (VC) matches the identifier included in the information about the target object and, if they match, allowing the certificate holder (Holder) to access the information about the target object.

5. The information processing system according to claim 4, wherein the verifiable credential (VC) includes information specifying information disclosable to the certificate holder (Holder) among the information about the target object, and the smart contract implements a function of, when determining whether to allow the certificate holder (Holder) to access the information about the target object, allowing the certificate holder (Holder) to access the information disclosable to the certificate holder (Holder) among the information about the target object.

6. The information processing system according to claim 1, wherein the target object is a target of a transaction conducted between the plurality of organizations, and the information about the target object is information about a history of the transaction.

7. An information processing method executed by an information processing system including a plurality of nodes configured using information processing apparatuses operated by each of a plurality of organizations and coupled so as to be communicable with each other, wherein at least some of the plurality of nodes function as nodes making up a distributed ledger system that provides a distributed ledger, and the distributed ledger system is capable of executing a smart contract in response to a transaction sent from the plurality of nodes,
the information processing method comprising:
managing, in the distributed ledger, information about a target object and DID (Decentralized Identity) documents including a DID of each participating organization, which is an organization participating in the distributed ledger, and a public key for the DID;
providing, by at least some of the plurality of nodes, an SSI management function, which is a function for managing a verifiable credential (VC) issued by a participating organization that is a certificate issuing organization (Issuer) using SSI technology (SSI: Self-Sovereign Identity) and a verifiable presentation (VP) issued by a participating organization that is a certificate holder (Holder) based on the verifiable credential (VC);
providing, by the SSI management function, the certificate holder (Holder) with the verifiable credential (VC) issued by the participating organization that is the certificate issuing organization (Issuer) for the target object and a private key corresponding to the public key for the DID of the certificate issuing organization (Issuer); and
managing, as the smart contract, a program that implements a function of determining whether to allow the certificate holder (Holder) to access the information about the target object managed in the distributed ledger, based on the verifiable presentation (VP) signed by the certificate holder (Holder) using the private key.

8. The information processing method according to claim 7, wherein the smart contract implements a function of, when determining whether to allow the certificate holder (Holder) to access the the target information about object, checking signatures attached to the verifiable credential (VC) and the verifiable presentation (VP) based on the DID document and, if the signatures attached to the verifiable credential (VC) and the verifiable presentation (VP) have not been tampered with, allowing the certificate holder (Holder) to access the information about the target object.

9. The information processing method according to claim 8, further comprising storing, by the distributed ledger system, an organization management ledger including information indicating the participating organizations,
wherein the smart contract implements a function of, when determining whether to allow the certificate holder (Holder) to access the information about the target object, checking whether the organization that issued the verifiable credential (VC) is included in the organization management ledger and, if the organization that issued the verifiable credential (VC) is included in the organization management ledger, allowing the certificate holder (Holder) to access the information about the target object.

10. The information processing method according to claim 9, wherein the verifiable credential (VC) includes an identifier of the target object, the information about the target object managed in the distributed ledger includes the identifier, and the smart contract implements a function of, when determining whether to allow the certificate holder (Holder) to access the information about the target object, checking whether the identifier of the target object included in the verifiable credential (VC) matches the identifier included in the information about the target object and, if they match, allowing the certificate holder (Holder) to access the information about the target object.

11. The information processing method according to claim 10, wherein the verifiable credential (VC) includes information specifying information disclosable to the certificate holder (Holder) among the information about the target object, and the smart contract implements a function of, when determining whether to allow the certificate holder (Holder) to access the information about the target object, allowing the certificate holder (Holder) to access the information disclosable to the certificate holder (Holder) among the information about the target object.

12. The information processing method according to claim 7, wherein the target object is a target of a transaction conducted between the plurality of organizations, and the information about the target object is information about a history of the transaction.
